(19) United States
(12) Patent Application Publication
(10) Pub. No.: US 2004/0192856 A1
(43) Pub. Date: Sep. 30, 2004

(54) Adhesive

(75) Inventors: Christoph Nagel, Hamburg (DE); Kerstin Gotz, Hamburg (DE); Andreas Westphal, Hamburg (DE); Christine Wilck, Hamburg (DE); Bernhard Gebbeken, Hamburg (DE)

Correspondence Address: Norris, McLaughlin & Marcus P.A., 30th Floor, 220 East 42nd Street, New York, NY, 10017, US

(73) Assignee: tesa Aktiengesellschaft, Hamburg (DE)

(21) Appl. No.: 10/720,820

(22) Filed: Nov. 24, 2003

(30) Foreign Application Priority Data
Mar. 26, 2003 (DE) 103 13 652.5

(51) Int. Cl. C08G 63/00

(52) U.S. Cl. 525/418

(57) ABSTRACT

Adhesive comprising having high shear strength and high tack, comprising

(a) 25 to 45% by weight of a polymer composed of

(a1) from 30 to 60% by weight of acrylic acid, from 30 to 60% by weight of butyl acrylate, from 0 to 40% by weight of ethylhexyl acrylate and from 0 to 10% by weight of a vinyl monomer; or

(a2) from 50 to 90% by weight of acrylic acid, from 10 to 50% by weight of butyl acrylate and from 0 to 10% by weight of a vinyl monomer; or

(a3) from 50 to 90% by weight of acrylic acid, from 30 to 5% by weight of butyl acrylate, from 30 to 5% by weight of ethylhexyl acrylate and from 0 to 10% by weight of a vinyl monomer;

(b) from 55 to 75% by weight of an ethoxylated C₂₀ alkylamine plasticizer and

(c) from 0.5 to 1.5% by weight of a crosslinker.

The invention relates to an adhesive for an adhesive tape which is used in the papermaking or paper-converting industry for flying roll changeover (flying splice) on, for example, coating machines or printing machines where temperature is applied.

### BACKGROUND OF THE INVENTION

In the papermaking or paper-converting industry a variety of adhesive tapes are known for flying splice. A particular feature of these adhesive tapes is the high tack, which is needed in order to ensure secure adhesive anchorage during roll changeover at high speeds.

Furthermore, high-shear-strength adhesive tapes are used for splice applications where the splice is exposed to elevated temperatures, as for example in calenders or in printing machines with a drying unit.

Where adhesive tapes for flying splice are exposed to elevated temperatures, there is a risk of the splice opening in application, since the adhesive suffers cohesive failure at the high temperature.

Where, on the other hand, adhesive tapes for high-temperature applications are used in a flying splice, there is a risk of the outgoing paper web not obtaining sufficient contact with the adhesive tape, with the consequence of failure during roll changeover.

Within the prior art there are a number of possibilities for solving this problem, and these are elucidated below. All of the solutions, however, harbour weaknesses through an increase in splicing costs and/or reduction in splicing efficiency.

On the one hand it is possible to raise the area of the adhesive bond by means of complex splice pattern geometries. Increasing the area of the adhesive bond is intended to improve the splice security in the thermal zone and/or to modify the contact area in such a way that even adhesive tapes of relatively low tack produce contact with the paper web.

On the other hand it is possible to reduce the speed during the actual splicing operation, thereby increasing the contact time and so making the splicing operation more secure.

Both processes, however, increase the costs or reduce the splicing efficiency and/or harbour the risk of tearing.

The adhesives used can be divided into repulpable adhesives (A) of high tack and repulpable adhesives (B) of high shear strength.

(A) As repulpable adhesives of high tack for flying splice it is possible to use acrylate self-adhesive compositions, which comprise a polymer of 30 to 60% acrylic acid, 30 to 60% butyl acrylate, 0 to 40% ethylhexyl acrylate and 0 to 10% of a vinyl monomer and also, as a plasticizer addition, ethoxylated alkylamines. The ethoxylated alkylamines are preferably ethoxylated C₁₆-C₁₈ alkylamines, which with further preference have from 2 to 25 ethoxy units.

The mixing proportion between plasticizer and polymer is from 55 to 75% by weight of plasticizer and from 25 to 45% by weight of polymer. The polymerization takes place free-radically in polar solvents. Partial crosslinking is accomplished with from 0.3 to 0.75% by weight of aluminium chelate, based on the total amount.

(B) As a repulpable adhesive of high shear strength for high temperature loads it is possible to use acrylate self-adhesive compositions, which comprise a polymer of 50 to 90% by weight acrylic acid, 10 to 50% by weight butyl acrylate and 0 to 10% of a vinyl monomer or of 50 to 90% by weight acrylic acid, 30 to 5% by weight butyl acrylate, 30 to 5% by weight ethylhexyl acrylate and 0 to 10% by weight of a vinyl monomer and also a plasticizer addition. As a plasticizer addition use is made of ethoxylated alkylamines, preferably ethoxylated C₁₆-C₁₈ alkylamines, which with further preference have from 2 to 25 ethoxy units. The mixing proportion of plasticizer and polymer is from 55 to 75% by weight of plasticizer and from 25 to 45% by weight of polymer.

The polymerization takes place free-radically in polar solvents. Partial crosslinking is accomplished with from 0.5 to 1.5% by weight of aluminium chelate, based on the total amount.

For the high-shear-strength compositions the fraction of the short-chain monomers, such as acrylic acid, for example, in the total polymer is raised and the fraction of the longer-chain esters is reduced. One consequence of this, however, is that these self-adhesive compositions exhibit significantly less tack.

### SUMMARY OF THE INVENTION

The present invention provides an adhesive having high shear strength and high tack.

The adhesive according to the present invention comprises

(a) 25 to 45% by weight of a polymer composed of (a1) from 30 to 60% by weight of acrylic acid, from 30 to 60% by weight of butyl acrylate, from 0 to 40% by weight of ethylhexyl acrylate and from 0 to 10% by weight of a vinyl monomer; or

(a2) from 50 to 90% by weight of acrylic acid, from 10 to 50% by weight of butyl acrylate and from 0 to 10% by weight of a vinyl monomer; or

(a3) from 50 to 90% by weight of acrylic acid, from 30 to 5% by weight of butyl acrylate, from 30 to 5% by weight of ethylhexyl acrylate and from 0 to 10% by weight of a vinyl monomer;

(b) from 55 to 75% by weight of an ethoxylated C₂₀ alkylamine plasticizer and

(c) from 0.5 to 1.5% by weight of a crosslinker.

Surprisingly it has been found that an adhesive of this kind exhibits significantly increased shear strengths in comparison with an adhesive defined under (B), the tack levels being virtually the same although exhibiting only a small drop. The invention accordingly provides high-shear-strength, high-tack, repulpable adhesives, thereby rendering the prior art solutions completely or very substantially dispensable. The adhesives of the invention, accordingly, can be used for flying splice where temperature is applied.

### DETAILED DESCRIPTION

The polymer is advantageously prepared by free-radical polymerization in polar solvents. The adhesive can be partly crosslinked through addition of a crosslinker, in which case it is preferred to mix in from 0.5 to 1% by weight of crosslinker, based on the total amount of the adhesive. A preferred crosslinker used is aluminium chelate.

One preferred adhesive comprises a polymer composed of 43% by weight of acrylic acid, 50% by weight of butyl acrylate and 7% by weight of a vinyl monomer. This polymer is advantageously prepared in a polar solvent by free-radical polymerization and ethoxylated C₂₀ alkylamine is added as plasticizer. The mixing proportion between plasticizer and polymer is 67% plasticizer and 33% polymer. Partial crosslinking is accomplished with 1% by weight of aluminium chelate, based on the total amount of the adhesive.

This adhesive surprisingly exhibits a significantly increased shear strength in comparison with the adhesives specified under (B), with only a slight drop in the tack levels.

Preferred compositions of the adhesive are set out in Table 1.

TABLE 1

| | Polymer | Plasticizer | Crosslinker |
|---|---|---|---|
| Ex. No. | (% by wt.) | (% by wt.) | (% by wt.) |
| 1 | 31 | 68.2 | 0.8 |
| 2 | 33 | 66 | 1 |
| 3 | 34.5 | 64.2 | 0.8 |
| 4 | 35 | 64.3 | 1.2 |

The adhesives of Examples 1, 3 and 4 gave high shear strengths with virtually the same tack properties as the adhesives described under (B). The adhesive of Example 1 gave a high shear strength with a very slight drop in the tack level as compared with the adhesives defined under (B).

We claim:

1. Adhesive comprising
(a) 25 to 45% by weight of a polymer composed of
(a1) from 30 to 60% by weight of acrylic acid, from 30 to 60% by weight of butyl acrylate, from 0 to 40% by weight of ethylhexyl acrylate and from 0 to 10% by weight of a vinyl monomer; or
(a2) from 50 to 90% by weight of acrylic acid, from 10 to 50% by weight of butyl acrylate and from 0 to 10% by weight of a vinyl monomer; or
(a3) from 50 to 90% by weight of acrylic acid, from 30 to 5% by weight of butyl acrylate, from 30 to 5% by weight of ethylhexyl acrylate and from 0 to 10% by weight of a vinyl monomer;
(b) from 55 to 75% by weight of an ethoxylated C₂₀ alkylamine plasticizer; and
(c) from 0.5 to 1.5% by weight of a crosslinker.

2. Adhesive according to claim 1, wherein the polymer has been free-radically polymerized in a polar solvent.

3. Adhesive according to claim 1, which is partly crosslinked.

4. Adhesive according to claim 1, wherein said crosslinker is aluminium chelate.

5. Adhesive according to claim 1, comprising
(a) 33% by weight of a polymer composed of 43% by weight of acrylic acid, 50% by weight of butyl acrylate and 7% by weight of a vinyl monomer;
(b) 66% by weight of an ethoxylated C₂₀ alkylamine plasticizer; and
(c) 1% by weight of aluminium chelate.
